(19) United States
(12) Patent Application Publication
(10) Pub. No.: US 2014/0174193 A1
(43) Pub. Date: Jun. 26, 2014

(54) METHOD, APPARATUS AND SAMPLE FOR EVALUATING BONDING STRENGTH

(71) Applicant: SAMSUNG ELECTRO-MECHANICS CO., LTD., Suwon (KR)

(72) Inventors: Gyu Seok KIM, Suwon (KR); Hee Suk CHUNG, Suwon (KR); Hyun Jung LEE, Suwon (KR); Suk-Jin HAM, Suwon (KR); Ju Wan NAM, Suwon (KR); Jin Uk CHA, Suwon (KR); Mi Yang KIM, Suwon (KR)

(73) Assignee: SAMSUNG ELECTRO-MECHANICS CO., LTD., Suwon (KR)

(21) Appl. No.: 13/772,481

(22) Filed: Feb. 21, 2013

(30) Foreign Application Priority Data
Dec. 21, 2012 (KR) 10-2012-0151013

(51) Int. Cl. G01N 3/08

(52) U.S. Cl. CPC G01N 3/08
USPC 73/821

(57) ABSTRACT

There are provided a method, an apparatus and a sample for evaluating bonding strength, the method including setting a micro-region including a bonded interface in an evaculated sample, forming a first groove in a circumferential portion of the micro-region to have a predetermined depth, processing a side of the micro-region to form a second groove connected to the bonded interface, and applying pressure on the micro-region to measure a critical point at which a delamination of the micro-region is generated.

### CROSS-REFERENCE TO RELATED APPLICATIONS

This application claims the priority of Korean Patent Application No. 10-2012-0151013 filed on Dec. 21, 2012, in the Korean Intellectual Property Office, the disclosure of which is incorporated herein by reference.

### BACKGROUND OF THE INVENTION

1. Field of the Invention

The present invention relates to a method, an apparatus and a sample for evaluating bonding strength, and more particularly, to a method, an apparatus and a sample for evaluating interface bonding strength of micro-regions.

2. Description of the Related Art

Currently, most electronic components are configured of a multilayer structure. When components and products in which multiple layers are bonded to each other in a process have weak bonding strength at interfaces between layers thereof, components and products may be delaminated in a subsequent process or may be delaminated in a process in which they are used by a user.

The bonding strength of the interface may be generated by a bond between molecules or atoms at a position where different materials are bonded or by surface roughness. Both of the former and the later may have a significant effect on the bonding strength. Particularly, in a substrate in which a bond between a polymer and a polymer or a polymer and a metal is made, the bonding strength at the interface therebetween is very important for a production yield rate of the substrate and practical usage of the substrate.

As described above, despite bonding strength being a factor having a significant effect on performance and reliability of the multilayer structure, development of a method and an apparatus for evaluating the bonding strength of the multilayer structure is insignificant as yet.

Meanwhile, a phenomenon of a delamination of two layers, observed macroscopically, is generated from a delamination or crack in two micro-scale regions. Here, since energy used in the occurrence of the delamination or the crack may be greater than the energy needed to propagate the delamination or the crack to surroundings thereof, an understanding of a mechanism by which the delamination or the crack is generated in the micro-region may be necessarily required for the understanding of and development of solutions to a phenomenon of a defective multilayer structure. Therefore, the development of a method or an apparatus for evaluating bonding strength capable of effectively evaluating the delamination phenomenon or the crack phenomenon in the micro-region is required.

For reference, as an example of the related art associated with the present invention, there is provided the invention of Patent Document 1. Patent Document 1 introduces a test method and an evaluating test apparatus for evaluating delamination resistance properties of a film. However, a technology introduced in Patent Document 1 has a limitation in testing delamination properties of a relatively thin sample such as a printed circuit board.

### RELATED ART DOCUMENT

(Patent Document 1) JP 1998-026583 A

### SUMMARY OF THE INVENTION

An aspect of the present invention provides a method, an apparatus and a sample for evaluating bonding strength, capable of accurately and effectively evaluating bonding strength of micro-regions.

According to an aspect of the present invention, there is provided a method for evaluating bonding force, the method including: setting a micro-region including a bonded interface in an evaculated sample; forming a first groove in a circumferential portion of the micro-region to have a predetermined depth; processing a side of the micro-region to form a second groove connected to the bonded interface; and applying pressure on the micro-region to measure a critical point at which a delamination of the micro-region is generated.

The first groove may be formed to have a “E” shape, having the micro-region in an interior thereof.

The first groove may be formed through a mechanical polishing process.

The second groove may be extended from an end portion of the micro-region to the bonded interface.

The second groove may be formed by a focused ion beam.

According to another aspect of the present invention, there is provided an apparatus for evaluating bonding force, the apparatus including: an upper holder having a reference surface disposed to be parallel to one surface of an evaluated sample; a lower holder supporting the upper holder so as to maintain the reference surface horizontally; and a pressing tip applying pressure on the evaluated sample.

The upper holder may include: a support; a sample supporting member protruded from the support and including a reference surface having a first inclined angle with respect to the support; and a coupling pin extended from the support in a downward direction.

The sample supporting member may have a longitudinal cross section of a right-angled triangle.

The lower holder may include: a body having an inclined surface having a second inclined angle; a coupling groove elongated perpendicularly with respect to the inclined surface and having the coupling pin inserted therein; and a coupling screw inserted into the coupling groove from a side of the body and allowing for fixation of the coupling pin inserted into the coupling groove.

A sum of the first inclined angle and the second inclined angle may be 90°.

According to another aspect of the present invention, there is provided a sample for evaluating bonding force, the sample including: a micro-region including a bonded interface and formed by a first groove having a predetermined depth; and a protrusion part separated by a second groove extended from an end portion of the micro-region to the bonded interface.

The protrusion part may have a cantilever form.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partially enlarged perspective view of a sample for evaluating bonding strength according to an embodiment of the present invention;

FIG. 2 is a cross-sectional view taken along line A-A of the sample for evaluating bonding strength shown in FIG. 1;

FIG. 3 is a configuration view of an apparatus for evaluating bonding strength according to an embodiment of the present invention;

FIG. 4 is a front view of an upper holder shown in FIG. 3;

FIG. 5 is a side view of the upper holder shown in FIG. 4;

FIG. 6 is a plan view of the upper holder shown in FIG. 4;

FIG. 7 is a front view of a lower holder shown in FIG. 3;

FIG. 8 is a side view of the lower holder shown in FIG. 7;

FIG. 9 is a plan view of the lower holder shown in FIG. 7;

FIG. 10 is a graph showing a result evaluated by a method for evaluating bonding strength according to an embodiment of the present invention; and

FIGS. 11A through 11C are views showing states of evaluated samples corresponding to respective steps indicated in FIG. 10.

### DETAILED DESCRIPTION OF THE EMBODIMENTS

Generally, a method for evaluating interface bonding strength of micro-regions has been performed in a method (hereinafter, referred to as an indentation test) in which force is applied to one surface of an evaluated sample until reaching a critical point at which delamination occurs at an interface at which members are bonded. However, the above-mentioned method has the following limitations.

First, in the case of a complex multilayer structure, it is difficult to precisely evaluate a delamination critical point.

In order to perform the indentation test for the evaluated sample, a significant hard support needs to be disposed under the evaluation sample. However, in the case in which a portion of members configuring the evaluated sample is formed of a soft material, even in the case in which the hard support is disposed under the evaluation sample, the soft material absorbs force applied to the evaluation sample, such that the evaluation sample may not be delaminated and precise coupling force may not be evaluated.

Second, a stress state is non-uniform.

When the indentation test is performed, a tip, an end of which has a circular shape or a triangular pyramid shape may be used. However, in the case in which an area of the tip is small, force applied by the tip is irregularly delivered to the evaluated sample, distribution of stress occurring in the evaluation sample may be non-uniform. In addition, in the case in which the area of the tip is small, normal stress and shear stress causing the delamination are simultaneously generated during a delamination progress, such that it is difficult to analyze evaluation results.

Third, reliability of the evaluation results is decreased.

The indentation test may be affected by roughness of the evaluated sample. For this reason, in the case in which the indentation test is performed for a plating layer or a polymer layer including an organic filler, it is difficult to obtain a reliable result.

Fourth, it is difficult to form a groove provided to be parallel to an interface.

The indentation test needs to form the groove in the evaluated sample in parallel with the interface. However, in the case in which the evaluated sample has a significantly thin thickness, it is difficult to form the groove provided to be parallel to the interface in the evaluation sample.

An aspect of the present invention provides method, an apparatus and a sample for evaluating bonding strength, capable of effectively performing bonding strength evaluation even for a thin evaluated sample.

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

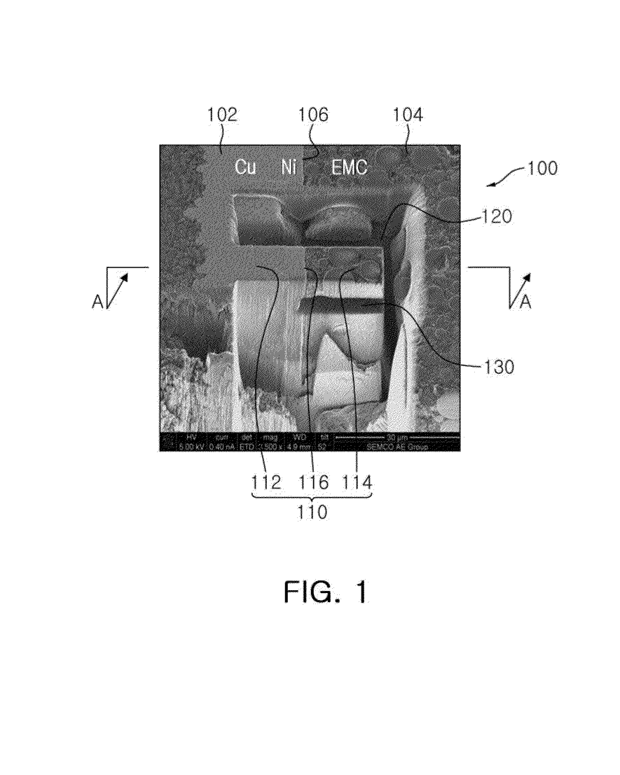

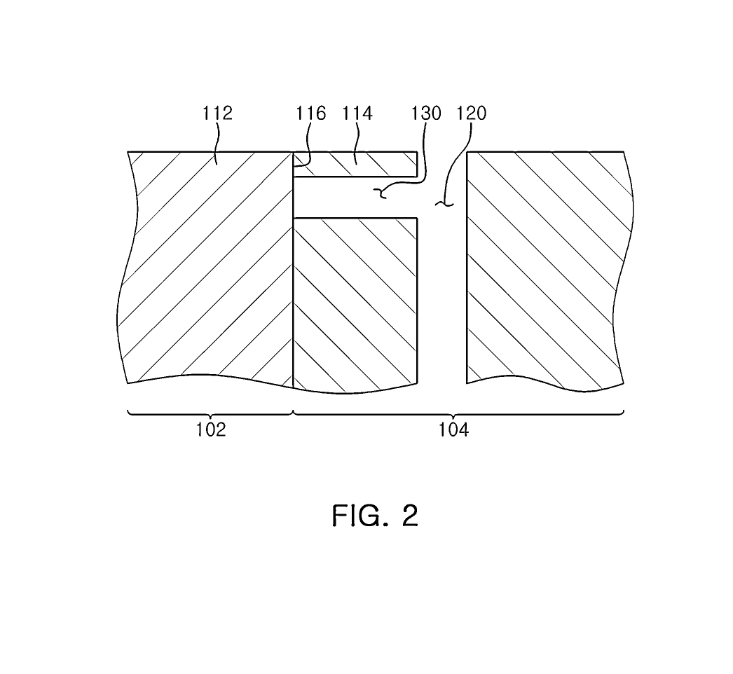

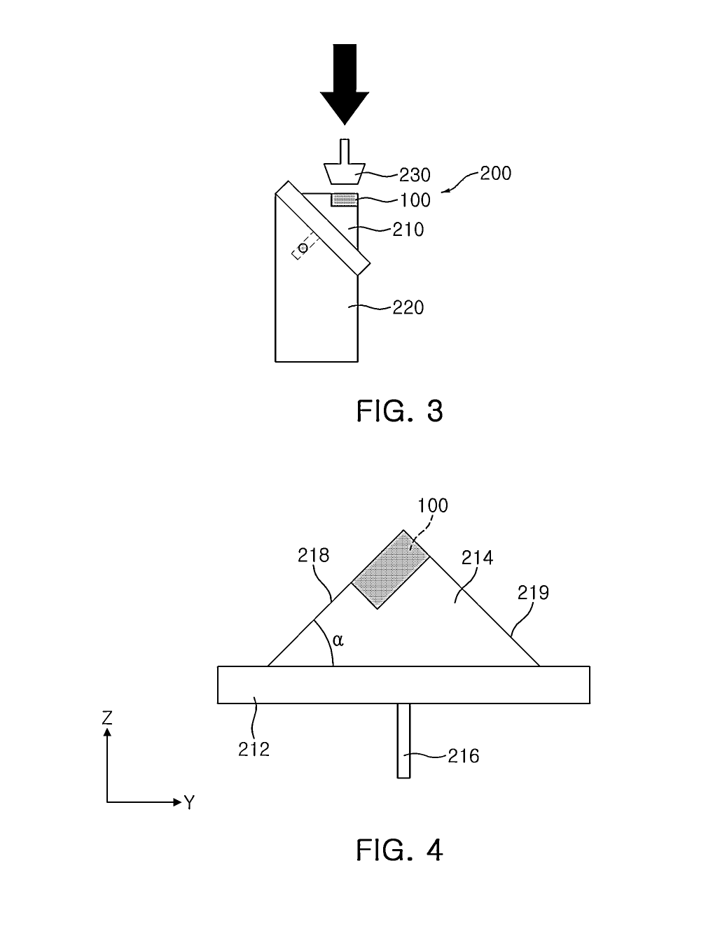

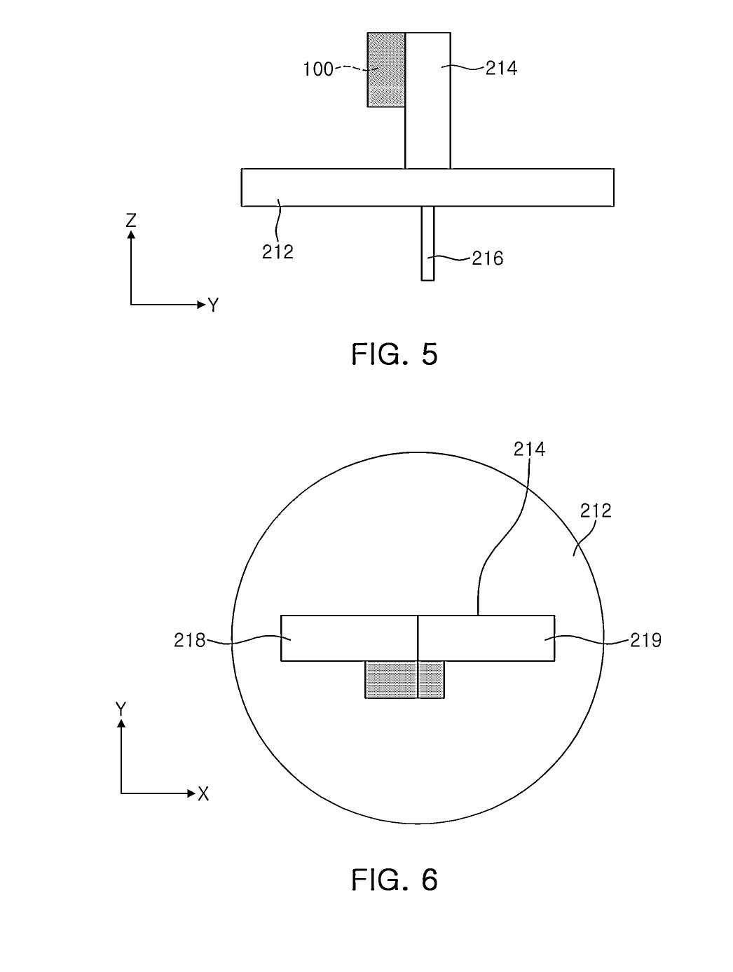

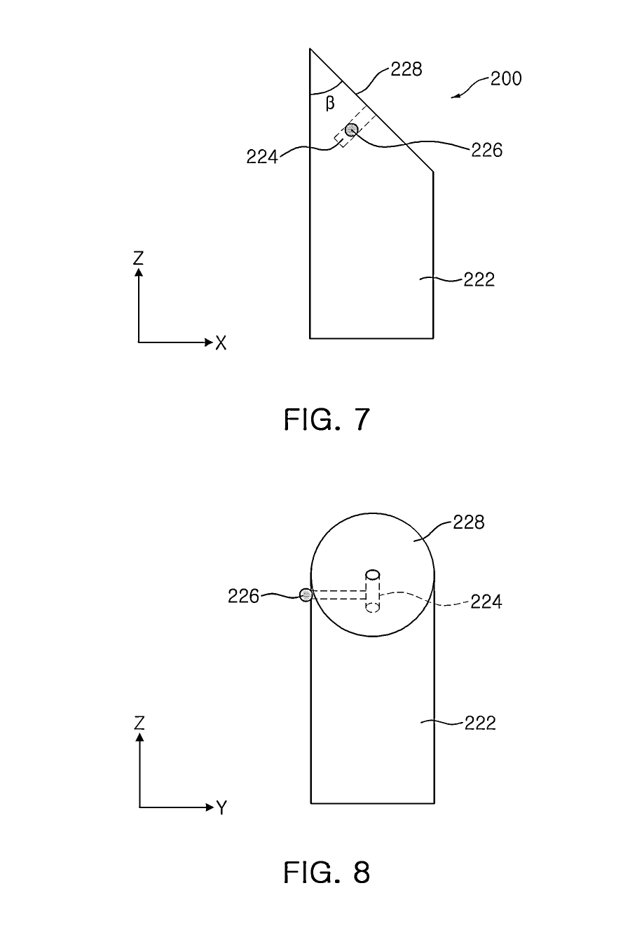

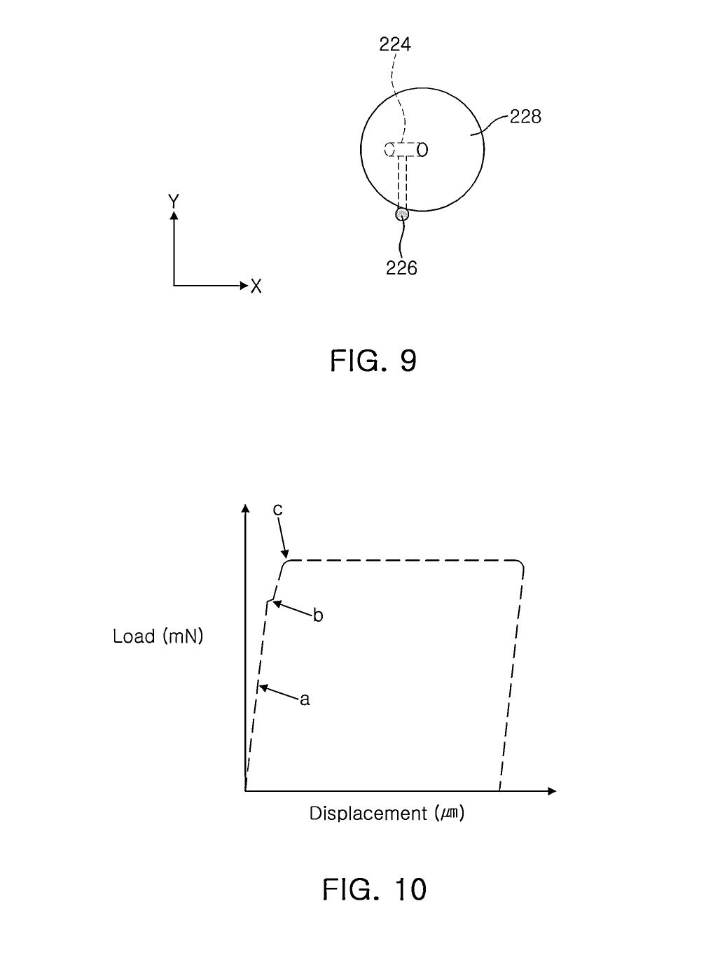

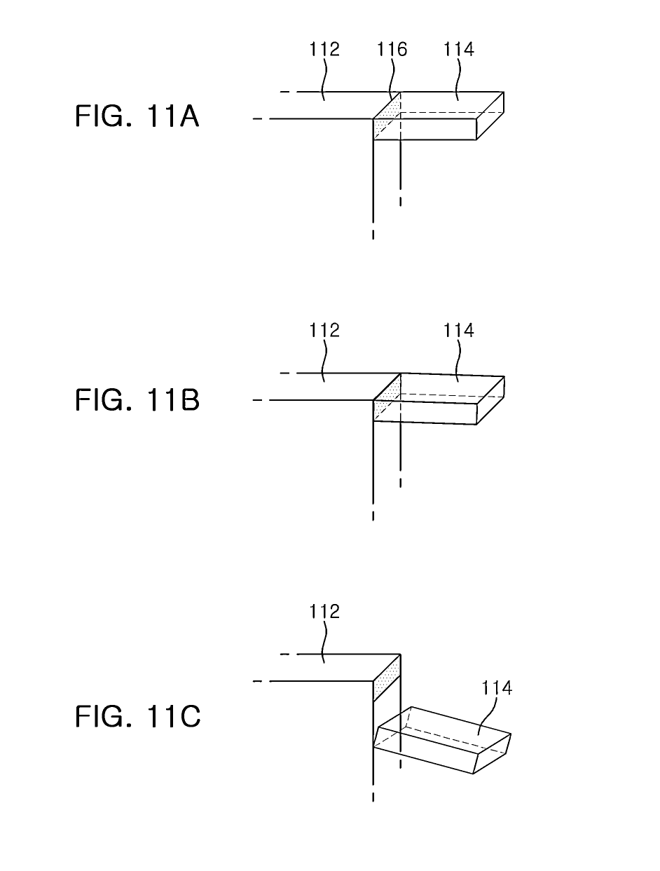

FIG. 1 is a partially enlarged perspective view of a sample for evaluating bonding strength according to an embodiment of the present invention, FIG. 2 is a cross-sectional view taken along line A-A of the sample for evaluating bonding strength shown in FIG. 1, FIG. 3 is a configuration view of an apparatus for evaluating bonding strength according to an embodiment of the present invention, FIG. 4 is a front view of an upper holder shown in FIG. 3, FIG. 5 is a side view of the upper holder shown in FIG. 4, FIG. 6 is a plan view of the upper holder shown in FIG. 4, FIG. 7 is a front view of a lower holder shown in FIG. 3, FIG. 8 is a side view of the lower holder shown in FIG. 7, FIG. 9 is a plan view of the lower holder shown in FIG. 7, FIG. 10 is a graph showing a result evaluated by a method for evaluating bonding strength according to an embodiment of the present invention, and FIGS. 11A through 11C are views showing states of evaluated samples corresponding to respective steps indicated in FIG. 10.

A sample for evaluating bonding strength according to an embodiment of the present invention will be described with reference to FIGS. 1 and 2.

The sample 100 for evaluating bonding strength may be a multilayer structure in which different members are bonded to each other. More specifically, the sample 100 for evaluating bonding strength may be a multilayer structure configured by bonding a first material member 102 to a second material member 104. Therefore, the sample 100 for evaluating bonding strength may be provided with an interface 106 at which the first material member 102 and the second material member 104 are in contact each other.

Here, the first material member 102 and the second material member 104 may be formed of the same material or formed of different materials from each other. For example, the sample 100 for evaluating bonding strength may be a multilayer structure in which a member formed of a polymer material and a member formed of a polymer material are bonded to each other, or a multilayer structure in which a member formed of a polymer material and a member formed of a metallic material are bonded to each other. In addition, the sample 100 for evaluating bonding strength may be a multilayer structure in which a member formed of a metallic material and a member formed of a metallic material are bonded to each other. For reference, the sample 100 for evaluating bonding strength shown in FIG. 1 is a multilayer structure configured by bonding a member formed of a nickel material to an epoxy molding compound (EMC).

The sample 100 for evaluating bonding strength may have a micro-region 110 for evaluating bonding strength. More specifically, the sample 100 for evaluating bonding strength may have the micro-region 110 formed by a mechanical processing. For example, the micro-region 110 may be formed by a first groove 120 formed to have a predetermined depth from one surface of the sample 100 for evaluating bonding strength. Here, the first groove 120 may be formed by using a focused ion beam for or mechanically polishing the sample 100 for evaluating bonding strength.

The micro-region 110 may be a region having the interface 106 at which the first material member 102 and the second material member 104 face each other. More specifically, the micro-region 110 may include a first region 112 formed of the first material member 102, and a second region 114 formed of the second material member 104. Here, the second region 114 may have at least three surface separated from neighboring regions by the first groove 120. To this end, a second groove 130 may be formed to have a “c” shape as shown in FIG. 1.

The second region 114 of the micro-region 110 may be provided with the second groove 130. More specifically, the second region 114 may be provided with the second groove 130 separating the second region 114 into two regions. Here, the second groove 130 may be extended from an end portion of the second region 114 to the interface 116 of the first region 112 and the second region 114. Therefore, two regions of the second region 114 separated by the second groove 130 may be connected to the first region 112 in a cantilever form as shown in FIG. 1, and the second region 114 may be utilized as a portion for evaluating bonding strength between the first material member 102 and the second material member 104. Here, the second groove 130 may be processed by the focused ion beam (FIB). However, a method for processing the second groove 130 is not limited to the focused ion beam, and the second groove 130 may be polished by other polishing methods as needed.

Meanwhile, although FIGS. 1 and 2 show a case in which the second groove 130 is extended to the interface 116 between the first region 112 and the second region 114, the second groove 130 may be extended to the first region 112 as needed.

In the sample 100 for evaluating bonding strength configured as described above, a region (that is, the second region 114) for evaluating bonding strength is completely separated from surrounding regions, such that the region may be effectively utilized as a sample for evaluating the bonding strength between the members 102 and 104. Therefore, a reliable evaluating result may be derived through the sample 100 for evaluating bonding strength.

Next, an apparatus for evaluating bonding strength according to an embodiment of the present invention will be described with reference to FIGS. 3 through 9.

An apparatus 200 for evaluating bonding strength according the present embodiment may include an upper holder 210, a lower holder 220, and a pressing tip 230 as shown in FIG. 3. Further, the apparatus 200 for evaluating bonding strength may further include a pressure device applying a predetermined force to the pressing tip 230 and a measuring device measuring a magnitude of the force applied by the pressure device.

The upper holder 210 may include a support 212, a sample supporting member 214, and a coupling pin 216 as shown in FIG. 4. The upper holder 210 configured as described above may have the sample 100 for evaluating bonding strength (hereinafter referred to as “evaluated sample 100), mounted thereon.

The support 212 may generally have a thin plate shape. More specifically, the support 212 may have a disk shape as shown in FIG. 6. However, a cross-section of the support 212 is not limited to a circular shape, but may be changed to other shapes as needed.

The sample supporting member 214 may be coupled to the support 212. The sample supporting member 214 may generally have a triangular shape. Specifically, a longitudinal cross-section of the sample supporting member 214 may be a triangle as shown in FIG. 4. More specifically, the longitudinal cross-section of the sample supporting member 214 may be a right-angled triangle in which an angle of a corner of is 90°. For reference, in the present embodiment, an angle of a portion of the sample supporting member 214 on which the evaluated sample 100 is mounted is 90°. The sample supporting member 214 may have a reference surface 218. The reference surface 218 may be disposed to be parallel to one surface of the evaluated sample 100. Further, the reference surface 218 may have a first inclined angle α with respect to the support 212. Here, the first inclined angle α may be less than 90°. Meanwhile, a surface 219 facing the reference surface 218 may be disposed to be parallel to another surface of the evaluated sample 100. Further, the surface 219 may have an angle of 90° with respect to the reference surface 218.

The coupling pin 216 may be formed on the support 210. Specifically, the coupling pin 216 may be extended from a lower portion of the support 212 in a downward direction and may be inserted into a coupling groove 224 of the lower holder 220. That is, the coupling pin 216 may serve to fix the upper holder 210 to the lower holder 220.

The upper holder 210 configured as described above may be used to process one surface of the evaluated sample 100. Specifically, the upper holder 210 may be used in forming the first groove 120 and the second groove 130 in the evaluated sample 100. Particularly, the upper holder 210 according to the present embodiment may support one side of the evaluated sample 100 in an oblique manner as shown in FIG. 4, such that the evaluated sample 100 may be easily processed.

The lower holder 220 may include a body 222, the coupling groove 224, and a coupling screw 226. The body 222 may have generally a cylindrical shape as shown in FIGS. 7 and 8. Here, one surface (an upper surface based on FIG. 7) of the body 222 may be provided as an inclined surface 228. The inclined surface 228 may have a second inclined angle β with respect to a vertical axis. Specifically, the second inclined angle β may be less than 90°. More specifically, the sum of the second inclined angle β and the first inclined angle α may be determined to be 90°. The coupling pin groove 224 may be formed in the inclined surface 228. Specifically, the coupling groove 224 may be elongated perpendicularly with respect to the inclined surface 228. The coupling screw 226 may be inserted into the coupling groove 224 from a side of the body 222. More specifically, the coupling screw 226 is protruded from the coupling groove 224, whereby it may allow for fixation of the coupling pin 216 inserted into the coupling groove 224 to be firmly fixed thereto.

The lower holder 220 configured as described above may be coupled to the upper holder 210 and support the upper holder 210. More specifically, the lower holder 220 may support the upper holder 210 so that the reference surface 218 of the upper holder 210 is maintained in a horizontal state.

The pressing tip 230 may be disposed on the upper holder 210 and may apply pressure on one surface of the evaluated sample 100 disposed to be parallel to the reference surface 218 of the upper holder 210. Specifically, the pressing tip 230 may apply pressure on the second region 114 (see FIG. 1) in the evaluated sample 100. Meanwhile, in the present embodiment, the pressing tip 230 may have a flat shaped end in order to uniformly apply force to the second region 114 as shown in FIG. 3. However, the end of the pressing tip 230 does not necessarily have the flat shape, but may be changed as needed.

The apparatus 200 for evaluating bonding force configured as described above may serve as a jig for processing a surface of the evaluated sample 100 and at the same time, serve as a jig for evaluation experimentation, such that the bonding force evaluation for the evaluated sample 100 may be promptly and easily undertaken. In addition, in the apparatus 200 for evaluating bonding force, the evaluated sample 100 is continuously fixed to the upper holder 210, such that reliability on an evaluation result may be improved.

Next, a method for evaluating bonding force according to an embodiment of the present invention will be described with reference to the above described sample and apparatus for evaluating bonding force. For reference, FIGS. 10 and 11 are views showing an evaluation result graph and states of the sample in order to describe the method for evaluating bonding force according to the embodiment of the present invention.

The method for evaluating bonding force according to the present embodiment may include an operation of setting a micro-region, an operation of separating the micro-region, and an operation of applying pressure. In addition, the method for evaluating bonding force may further include an operation of analyzing numerical values of a pressurized result.

1) Operation of Setting Micro-Region

In the operation, a region including the interface 106 at which the members are bonded may be set as the micro-region 110 in the sample 100. For example, in the operation, a portion in which two members are boned in the sample 100 having a multilayer structure may be set as the micro-region 110. Therefore, the micro-region 110 may include the interface 106 at which the first material member 102 and the second material member 104 are in contact with each other.

2) Operation of Separating Micro-Region

In the operation, the micro-region 110 may be formed. That is, in the operation, the first groove 120 and the second groove 130 may be formed such that the micro-region 110 set in the previous operation may be separated from other regions. Specifically, the first groove 120 may be formed to have a predetermined depth from one surface of the sample 100, whereby the micro-region 110 may be separated from other regions. In addition, the second groove 130 may be extended from the end portion of the micro-region 110 to the interface 116, whereby the second region 114 connected to the first region 112 of the micro-region 110 in a cantilever form may be formed. Here, the first groove 120 may be formed through a mechanical polishing process and the second groove 130 may be formed by a processing method using focused ion beam.

3) Operation of Applying Pressure

In the operation, the second region 114 of the micro-region 110 may be pressurized. Specifically, in the operation, force is applied to the second region 114 such that separation between the first region 112 and the second region 114 is generated in the micro-region 110. In addition, in the operation, a process in which a separation phenomenon (or a delamination phenomenon) between the first region 112 and the second region 114 is generated may be evacuated.

FIG. 10 is a graph showing a relationship between displacement and a load and FIGS. 11A through 11C are views schematically showing states of the regions according to the operations shown in FIG. 10.

As shown in FIG. 10, a predetermined displacement is merely generated between the first region 112 and the second region 114 even in the case in which a load is increased, and a bonded state of the regions was maintained (“a” in FIG. 10 and FIG. 11A). Then, after a predetermined time has elapsed, the amount of the displacement is increased and a local separation between the first region 112 and the second region 114 may be generated (“b” in FIG. 10 and FIG. 11B). Further, in the case in which the load is continuously increased, the amount of displacement is increased and as a result, the first region 112 is separated from the second region 114 (“c” in FIG. 10 and FIG. 11C).

Meanwhile, in FIG. 10, the load is divided by a bond area in which the first region 112 and the second region 114 are bonded and the amount of the displacement is divided by a thickness of a contact interface to be represented by a stress-strain curve, such that fracture toughness, a capability of resisting against fracture may be obtained.

As set forth above, according to the embodiments of the present invention, bonding strength of a multilayer structure can be reliably evaluated.

Further, both absorption behavior and high temperature behavior occurring at a bonded interface of a multilayer structure can be evaluated.

While the present invention has been shown and described in connection with the embodiments, it will be apparent to those skilled in the art that modifications and variations can be made without departing from the spirit and scope of the invention as defined by the appended claims.

What is claimed is:

1. A method for evaluating bonding force, the method comprising:
setting a micro-region including a bonded interface in an evaculated sample;
forming a first groove in a circumferential portion of the micro-region to have a predetermined depth;
processing a side of the micro-region to form a second groove connected to the bonded interface; and
applying pressure on the micro-region to measure a critical point at which a delamination of the micro-region is generated.

2. The method of claim 1, wherein the first groove is formed to have a “E” shape, having the micro-region in an interior thereof.

3. The method of claim 1, wherein the first groove is formed through a mechanical polishing process.

4. The method of claim 1, wherein the second groove is extended from an end portion of the micro-region to the bonded interface.

5. The method of claim 1, wherein the second groove is formed by a focused ion beam.

6. An apparatus for evaluating bonding force, the apparatus comprising:
an upper holder having a reference surface disposed to be parallel to one surface of an evaluated sample;
a lower holder supporting the upper holder so as to maintain the reference surface horizontally; and
a pressing tip applying pressure on the evaluated sample.

7. The apparatus of claim 6, wherein the upper holder includes:
a support;
a sample supporting member protruded from the support and including a reference surface having a first inclined angle with respect to the support; and
a coupling pin extended from the support in a downward direction.

8. The apparatus of claim 7, wherein the sample supporting member has a longitudinal cross section of a right-angled triangle.

9. The apparatus of claim 7, wherein the lower holder includes:
a body having an inclined surface having a second inclined angle;
a coupling groove elongated perpendicularly with respect to the inclined surface and having the coupling pin inserted therein; and
a coupling screw inserted into the coupling groove from a side of the body and allowing for fixation of the coupling pin inserted into the coupling groove.

10. The apparatus of claim 9, wherein a sum of the first inclined angle and the second inclined angle is 90°.

11. A sample for evaluating bonding force, the sample comprising:
a micro-region including a bonded interface and formed by a first groove having a predetermined depth; and
a protrusion part separated by a second groove extended from an end portion of the micro-region to the bonded interface.

12. The sample of claim 11, wherein the protrusion part has a cantilever form.
